(19) United States
(12) Patent Application Publication
(10) Pub. No.: US 2014/0269602 A1
(43) Pub. Date: Sep. 18, 2014

(54) WIRELESS COMMUNICATION DEVICE AND WIRELESS COMMUNICATION METHOD

(71) Applicant: Toshio Kawagishi, Tokyo (JP)

(72) Inventor: Toshio Kawagishi, Tokyo (JP)

(73) Assignee: MITSUBISHI ELECTRIC CORPORATION, Tokyo (JP)

(21) Appl. No.: 14/354,169

(22) PCT Filed: Jan. 13, 2012
(86) PCT No.: PCT/JP2012/050585

§ 371 Date: Apr. 25, 2014

(51) Int. Cl. H04W 72/04

(52) U.S. Cl. CPC H04W 72/04
USPC 370/329

(57) ABSTRACT

An object of the present invention is to provide a wireless communication device capable of obtaining an idle communication channel with a simple configuration, and to provide a wireless communication method thereof. In the present invention, wireless communication is performed with a counterpart device by using Bluetooth. A communication status to the counterpart device in this wireless communication, for example, a packet type of a communication packet being used is acquired by status acquisition unit. A usable idle communication channel is calculated by channel calculation unit based on the acquired packet type. Notification information including idle communication channel information related to the calculated idle communication channel is outputted, for example, by display output unit or voice output unit.

### TECHNICAL FIELD

The present invention relates to a wireless communication device that performs wireless communication with a counterpart device, and to a wireless communication method between the counterpart device and the wireless communication device.

### BACKGROUND ART

In the wireless communication device, wireless communication with a counterpart device as a communication counterpart is performed by using a plurality of communication channels. The wireless communication device is capable of simultaneously performing the communication with counterpart devices, the number of which being equal to that of communication channels. Each of the counterpart devices can start the communication with the wireless communication device in a case where there is an idle communication channel (hereinafter, referred to as “idle channel”), which is a communication channel not in use, in the wireless communication device. A technology for notifying a user of a communication status such as presence of an idle channel is disclosed, for example, in Patent Documents 1 to 3.

In Patent Document 1, a wireless communication system including a wireless master unit and a plurality of wireless slave units is disclosed. In the wireless communication system disclosed in Patent Document 1, reception radio wave intensities of the plurality of communication channels are measured by the wireless master unit and the plural wireless slave units, measurement data is statistically processed by the wireless master unit, and a processing result is displayed on displays of the wireless master unit and the wireless slave units.

In Patent Document 2, a channel state display of a cordless phone constituted by a connection device and a mobile terminal is disclosed. The channel state display monitors presence of radio waves of a control channel and an idle calling channel, and displays the radio waves at a time when the radio waves are detected. The idle calling channel corresponds to the idle communication channel.

In Patent Document 3, a personal handy phone system constituted by a radio base station and personal handy phones is disclosed. The radio base station grasps usages of voice channels in an area, and determines whether or not there is vacancy in the voice channel.

The radio base station assigns an idle bit of a broadcast control channel (abbreviated as: BCCH) as a broadcast bit for broadcasting the usages of the voice channels, and sends out the BCCH. The personal handy phone receives the BCCH from the radio base station to extract the broadcast bit, and determines the broadcast bit to display communication probability information on a display.

### PRIOR ART DOCUMENTS

### Patent Documents

Patent Document 1: Japanese Patent Application Laid-Open No. 2004-187089
Patent Document 2: Japanese Patent Application Laid-Open No. H04-213932
Patent Document 3: Japanese Patent Application Laid-Open No. H10-313480

### SUMMARY OF INVENTION

### Problems to be Solved by the Invention

As mentioned above, in the technology disclosed in Patent Document 1, the reception radio wave intensities of the plurality of communication channels are measured, and the measurement data is statistically processed, whereby the communication status is obtained. In the technology disclosed in Patent Document 2, the presence of the radio waves is monitored, whereby the communication status is obtained. In the technology disclosed in Patent Document 3, the communication status is obtained by using information about the voice channels for use in an exchange.

As described above, in the technologies disclosed in Patent Documents 1 to 3, it is necessary to provide means for obtaining the communication status, such as means for measuring the reception radio wave intensities, and there is a problem that the device becomes complicated.

An object of the present invention is to provide a wireless communication device capable of obtaining the idle communication channel with a simple configuration, and to provide a wireless communication method thereof.

### Means for Solving the Problems

A wireless communication device of the present invention includes: wireless communication means for performing wireless communication with a counterpart device by using Bluetooth; status acquisition means for acquiring a communication status of the wireless communication performed by the wireless communication means; and channel calculation means for calculating an idle communication channel based on the communication status acquired by the status acquisition means, the idle communication channel being usable by the wireless communication means in the wireless communication, wherein the communication status includes a packet type of a communication packet being used, and the channel calculation means calculates the idle communication channel based on the packet type.

A wireless communication method of the present invention is a wireless communication method of performing wireless communication with a counterpart device by using Bluetooth, the wireless communication method including: a status acquisition step of acquiring a communication status of the wireless communication; and a channel calculation step of calculating an idle communication channel based on the communication status acquired by the status acquisition step, the idle communication channel being usable in the wireless communication, wherein the communication status includes a packet type of a communication packet being used, and the idle communication channel is calculated based on the packet type in the channel calculation step.

### Effects of the Invention

In accordance with the wireless communication device of the present invention, the idle communication channel is calculated by the channel calculation means based on the communication status acquired by the status acquisition means. The communication status includes the packet type of the communication packet that is being used. The idle communication channel is calculated based on this packet type. In this way, unlike the conventional technology, the idle communication channel can be obtained without providing means for obtaining the communication status, such as means for measuring radio wave intensity. Hence, the idle communication channel can be obtained with a simple configuration.

In accordance with the wireless communication method of the present invention, the idle communication channel is calculated in the channel calculation step based on the communication status acquired in the status acquisition step. The communication status includes the packet type of the communication packet that is being used. The idle communication channel is calculated based on this packet type. In this way, unlike the conventional technology, the idle communication channel can be obtained without using means for obtaining the communication status, such as means for measuring the radio wave intensity. Hence, the idle communication channel can be obtained with a simple configuration.

Objects, features, aspects and advantages of the present invention will be more apparent by the following detailed description and the accompanying drawings.

### BRIEF DESCRIPTION OF DRAWINGS

FIG. 1 is a block diagram showing a configuration of a wireless communication device 1 as an embodiment of the present invention.

FIG. 2 is a flowchart showing a processing procedure of a wireless communication device 1, which is related to monitoring processing for a communication status.

FIG. 3 is a view showing an example of a transmission/reception status of a communication packet in wireless communication between the wireless communication device 1 and counterpart devices 2.

FIG. 4 is a view showing an example of the transmission/reception status of communication packets in the wireless communication between the wireless communication device 1 and the counterpart devices 2.

FIG. 5 is a view showing an example of a sequence in the wireless communication device 1 in a case of displaying the communication status on a display output device 14.

FIG. 6 is a view showing the example of the sequence in the wireless communication device 1 in the case of displaying the communication status on the display output device 14.

FIG. 7 is a view showing the example of the sequence in the wireless communication device 1 in the case of displaying the communication status on the display output device 14.

FIG. 8 is a perspective view showing an exterior appearance of the wireless communication device 1.

FIG. 9 is a view showing a display example of the communication status in the wireless communication device 1.

FIG. 10 is a view showing a display example of the communication status in the wireless communication device 1.

FIG. 11 is a view showing a display example of the communication status in the wireless communication device 1.

FIG. 12 is a view showing a display example of the communication status in the wireless communication device 1.

FIG. 13 is a view showing a different display example of the communication status in the wireless communication device 1.

FIG. 14 is a view showing the different display example of the communication status in the wireless communication device 1.

FIG. 15 is a view showing an example of a sequence in a case of displaying the communication status on a display output devices of the counterpart devices 2.

FIG. 16 is a view showing the example of the sequence in the case of displaying the communication status on the display output devices of the counterpart devices 2.

FIG. 17 is a view showing the example of the sequence in the case of displaying the communication status on the display output devices of the counterpart devices 2.

### DESCRIPTION OF EMBODIMENT

FIG. 1 is a block diagram showing a configuration of a wireless communication device 1 as an embodiment of the present invention. The wireless communication device 1 is a device that is capable of wireless communication using Bluetooth (registered trademark) that is a short-distance wireless communication standard. For example, the wireless communication device 1 is realized by a navigation device. For example, the wireless communication device 1 is mounted on an automobile, and is used as a car navigation device.

The wireless communication device 1 is configured so as to be capable of the wireless communication with a plurality of counterpart devices 2 by using Bluetooth. Hereinafter, the plurality of counterpart devices 2 are distinctively referred to as a first counterpart device A1 to an N-th counterpart device AN (N is a natural number). Each of the counterpart devices 2 includes wireless communication means (not shown) for performing the wireless communication by using Bluetooth. For example, the counterpart device 2 is realized by an audio media player or a cellular phone, which is capable of watching and listening to a video and a voice.

The wireless communication device 1 includes a central processing unit (abbreviated as: CPU) 10; a storage 11; a wireless communication unit 12; an information input device 13; a display output device 14; and a voice output device 15. The CPU 10 includes: an integrated controller 20; a communication channel (abbreviated as: CH) manager 21; a wireless communication controller 22; an information input controller 23; a display output controller 24; and a voice output controller 25.

The storage 11 is realized by a nonvolatile memory capable of reading and writing a large capacity. The storage 11 is configured so as to be capable of writing processing and reading processing by the integrated controller 20 of the CPU 10.

The storage 11 stores information given from the integrated controller 20. The information given from the integrated controller 20 is information related to the wireless communication with each of the counterpart devices 2, for example, address information of the wireless communication device 1 and communication status information. The communication status information is information related to a communication status acquired by the communication CH manager 21 described later. In a case where the wireless communication device 1 is realized by the navigation device, the storage 11 stores information necessary for navigation, for example, map information.

The wireless communication unit 12 corresponds to wireless communication means. The wireless communication unit 12 performs the wireless communication with each of the counterpart devices 2. In this embodiment, the wireless communication unit 12 performs the wireless communication with each of the counterpart devices 2 by using Bluetooth. Upon receiving a signal from the counterpart device 2, the wireless communication unit 12 demodulates the received signal, and gives the demodulated signal to the wireless communication controller 22. Moreover, upon being given a signal, which is to be transmitted, from the wireless communication controller 22, the wireless communication unit 12 modulates and amplifies the given signal, and transmits the modulated and amplified signal to the counterpart device 2.

The integrated controller 20 is electrically connected to the communication CH manager 21, the wireless communication controller 22, the information input controller 23, the display output controller 24 and the voice output controller 25, which constitute the CPU 10. The integrated controller 20 integrally controls the wireless communication device 1 in accordance with a control program stored in a memory (not shown) built therein.

From the wireless communication controller 22, the communication CH manager 21 acquires a communication status of the wireless communication performed by the wireless communication unit 12, that is, the communication status with the counterpart device 2, and manages the acquired communication status. The communication CH manager 21 corresponds to status acquisition means.

For example, the communication status includes: a packet type as a type of a packet (hereinafter, referred to as “communication packet”) being used in the wireless communication with the counterpart device 2; intensity of a radio wave received from the counterpart device 2; and presence of an error. The communication status may include an error rate. Here, the error rate refers to a ratio of the number of error packets, which is received by the counterpart device 2, with respect to the total number of packets transmitted from the wireless communication device 1. The communication status at least includes the packet type of the communication packet used in the wireless communication with the counterpart device 2.

On the basis of the packet type of the communication packet that is being used, the communication CH manager 21 calculates the idle communication channel, which is a channel that is not used at that point of time. The communication CH manager 21 corresponds to channel calculation means.

The wireless communication controller 22 controls the wireless communication unit 12 based on a control command given from the integrated controller 20. The wireless communication controller 22 gives a signal, which is given from the wireless communication unit 12, to the integrated controller 20 and the communication CH manager 21. The wireless communication controller 22 gives a signal, which is given from the integrated controller 20 or the communication CH manager 21, to the wireless communication unit 12 based on the control command given from the integrated controller 20.

For example, the information input device 13 is constituted by: a touch panel, a remote controller, an operation button, which are operated by a user; a voice input device having a voice recognition function; and the like. The information input device 13 is used when the user inputs information such as number information, character information and instruction information to the wireless communication device 1. When the information input device 13 is operated by the user, the information input device 13 generates an operation signal, which indicates information corresponding to the operation of the user, and gives the generated operation signal to the information input controller 23.

The information input controller 23 gives the operation signal, which is given from the information input device 13, to the integrated controller 20. Hence, by operating the information input device 13, the user of the wireless communication device 1 give the information, which corresponds to the operation, to the information input controller 23 and the integrated controller 20.

On the basis of the control command given from the integrated controller 20, the display output controller 24 converts display-use video data, which is given from the integrated controller 20, into a video signal capable of being handled by the display output device 14, and gives the video signal to the display output device 14.

For example, the display output device 14 is realized by a liquid crystal display. The display output device 14 displays a video, which is indicated by the video signal given from the display output controller 24. The display output device 14 corresponds to display output means.

Based on the control command given from the integrated controller 20, the voice output controller 25 converts voice data, which is given from the integrated controller 20, into a voice signal capable of being handled by the voice output device 15, and gives the voice signal to the voice output device 15.

For example, the voice output device 15 is realized by speakers. The voice output device 15 outputs a voice, which is indicated by the voice signal given from the voice output controller 25. The voice output device 15 corresponds to voice output means.

FIG. 2 is a flowchart showing a processing procedure of the wireless communication device 1, which is related to monitoring processing for the communication status. Respective pieces of processing of the flowchart shown in FIG. 2 are executed by the integrated controller 20, the communication CH manager 21, the wireless communication controller 22 and the wireless communication unit 12. When the power of the wireless communication device 1 is turned on, and the integrated controller 20, the communication CH manager 21, the wireless communication controller 22 and the wireless communication unit 12 are activated, then the processing proceeds to Step S1, and the processing procedure of this flowchart is started.

In Step S1, the wireless communication controller 22 determines whether or not the communication has occurred. In Step S1, in a case where it is determined that the communication has occurred, the processing proceeds to Step S2, and in a case where it is determined that the communication has not occurred, the wireless communication controller 22 is on standby until the communication occurs. The wireless communication controller 22 determines whether or not the communication has occurred based on whether or not communication between the wireless communication device 1 and the counterpart device 2 is established. That is to say, in a case where the communication with the counterpart device 2 is established, then the wireless communication controller 22 determines that the communication has occurred, and in a case where the communication with the counterpart device 2 is not established, then the wireless communication controller 22 determines that the communication has not occurred.

In Step S2, the communication CH manager 21 acquires a communication status at the present point of time from the wireless communication controller 22. For example, in a case where the communication status is idle communication channel information, the communication CH manager 21 confirms a packet type of a packet, which is being used for the communication with the counterpart device 2 at the present point of time, through the wireless communication controller 22.

Based on the confirmed packet type, the communication CH manager 21 calculates the idle communication channel, which is the channel that is not being used at the present point of time. The communication CH manager 21 holds, as the communication status, the idle communication channel information indicating the calculated idle communication channel. When the communication status is acquired as described above, the processing proceeds to Step S3.

In Step S3, the communication CH manager 21 notifies the communication status, which is acquired in Step S2, to the display output device 14 through the integrated controller 20 and the display output controller 24. The display output device 14 displays a video, which shows the notified communication status. In this way, the communication status is notified to the user by the video.

Specifically, the communication CH manager 21 notifies the communication status, which is acquired in Step S2, to the integrated controller 20. The integrated controller 20 generates the display-use video data based on the notified communication status, and gives the generated display-use video data to the display output controller 24. The display output controller 24 converts the video data, which is given from the integrated controller 20, into the video signal, and gives the video signal to the display output device 14. The display output device 14 displays a video based on the video signal given from the display output controller 24. In this way, the video showing the communication status is displayed by the display output device 14. In this way, the communication status is notified to the user by the video.

In the above-described process, the integrated controller 20 stores the communication status, which is notified from the communication CH manager 21, as the communication status information in the storage 11. When the communication status is notified, then the processing proceeds to Step S4.

In Step S3, the communication CH manager 21 may notify the communication status, which is acquired in Step S2, to the voice output device 15 through the integrated controller 20 and the voice output controller 25. In this case, the integrated controller 20 generates the voice data based on the communication status notified from the communication CH manager 21, and gives the generated voice data to the voice output controller 25. The voice output controller 25 converts the voice data, which is given from the integrated controller 20, into the voice signal, and gives the voice signal to the voice output device 15.

The voice output device 15 outputs the voice based on the output signal given from the voice output controller 25. In such a way, the voice indicating the communication status is outputted by the voice output device 15. In this way, the communication status is notified to the user by the voice. The notification of the communication status to the user in Step S3 may be performed by either of the video and the voice, or may be performed by both of the video and the voice.

In Step S4, the wireless communication controller 22 determines whether or not the communication between the wireless communication device 1 and the counterpart device 2 is disconnected. In Step S4, in a case where it is determined that the communication is disconnected, the processing proceeds to Step S5, and in a case where it is determined that the communication is not disconnected, the processing returns to Step S2.

In Step S5, the communication CH manager 21 initializes the communication status, which is stored in the storage 11, through the integrated controller 20. Specifically, the communication CH manager 21 deletes the communication status, which is stored in the storage 11 in Step S3, from the storage 11 through the integrated controller 20. When the communication status is initialized, the processing proceeds to Step S6.

In Step S6, the communication CH manager 21 notifies the initialized communication status to the display output device 14 through the integrated controller 20 and the display output controller 24, and the display output device 14 displays the video showing the notified communication status.

In a case of having notified the communication status to the voice output device 15 in Step S3, the communication CH manager 21 notifies the initialized communication status to the voice output device 15 through the integrated controller 20 and the voice output controller 25 in Step S6, and the voice output device 15 outputs the voice indicating the notified communication status. In this way, the processing procedure is entirely ended.

The communication CH manager 21 calculates the idle communication channel in such a manner as follows. FIG. 3 and FIG. 4 are views each showing an example of a transmission/reception status of the communication packet in the wireless communication between the wireless communication device 1 and the counterpart device 2. FIG. 3 and FIG. 4 show cases of performing the wireless communication by using Bluetooth.

FIG. 3 shows an example of a case where the wireless communication device 1 performs communication only with the first counterpart device A1 by using an HV3 packet. In this case, in Step S2 shown in FIG. 2 mentioned above, the communication CH manager 21 confirms that a packet type of the packet, which is being used, is HV3.

A transmission cycle F of such an HV3 packet is 3.75 msec, and corresponds to three pieces of time slots TS, each of which is a set formed by combining a communication slot, which is used for the transmission, and a communication slot, which is used for the reception, with each other. That is to say, the HV3 packet is transmitted/received in one time slot TS among the three time slots TS included in one cycle of the transmission cycle F.

In the rest of two time slots TS, the wireless communication device 1 is capable of the wireless communication with other counterpart devices 2. Hence, the communication CH manager 21 calculates that idle slots corresponding to the idle communication channels are “2”.

As described above, the communication CH manager 21 calculates a value, which is obtained by subtracting “the number of counterpart devices 2 under communication” from “the number of time slots TS included in one cycle of the transmission cycle F”, as the number of idle slots, that is, the number of idle communication channels.

FIG. 4 shows an example of a case where the wireless communication device 1 performs the communication with the first counterpart device A1 and the second counterpart device A2 by using the HV3 packets. In FIG. 4, the HV3 packet transmitted/received to/from the first counterpart device A1 is represented by a hollow block, and the HV3 packet transmitted/received to/from the second counterpart device A2 is represented by diagonal hatching.

In this case, in Step S2 shown in FIG. 2 mentioned above, the communication CH manager 21 calculates as 3−2=1 since the packet type of the packet, which is being used, is the HV3, and then calculates that the idle slot corresponding to the idle communication channel is “1”.

As the packet type of the communication packet used in Bluetooth, there are an HV1 packet and an HV2 packet as well as the HV3 packet. A transmission cycle F of the HV1 packet is 1.25 msec, and corresponds to two pieces of the communication slots, that is, one piece of the time slots TS. Hence, in a case where the packet type of the communication packet, which is being used, is the HV1 packet, the communication CH manager 21 calculates as 1−1=0, and calculates that the number of idle communication channels is “zero (0)”.

A transmission cycle F of the HV2 packet is 2.5 msec, and corresponds to four pieces of the communication slots, that is, two pieces of the time slots TS. Hence, in a case where the packet type of the communication packet, which is being used, is the HV2 packet, the communication CH manager 21 calculates as 2−1=1, and calculates that the number of idle communication channels is “1”.

FIG. 5 to FIG. 7 are views showing an example of a sequence in the wireless communication device 1 in a case of displaying the communication status on the display output device 14. FIG. 5 to FIG. 7 show a case where the wireless communication device 1 is in an operation state in Step a1, the first counterpart device A1 is in an operation state in Step a2, and the N-th device AN is in an operation state in Step a3.

In Step a4, the information input device 13 is operated by the user, to input a connection request for requesting a connection to the first counterpart device A1, and the inputted connection request is transmitted as a connection request signal to the communication CH manager 21 through the information input controller 23 and the integrated controller 20.

Upon receiving the connection request signal in Step a4, in Step a5, processing for establishing the communication with the first counterpart device A1 is performed by the wireless communication device 1. In this way, the wireless communication device 1 and the first counterpart device A1 turn to a communication state.

When the wireless communication device 1 and the first counterpart device A1 turn to the communication state in such a manner, then in Step a6, the wireless communication controller 22 notifies a communication occurrence signal, which represents that the communication has occurred, to the communication CH manager 21.

In Step a7, the communication CH manager 21 transmits an acquisition request signal, which represents a communication status acquisition request for requesting acquisition of the communication status at the present point of time, to the wireless communication controller 22. In Step a8, the wireless communication controller 22 acquires the communication status at the present point of time, and transmits, to the communication CH manager 21, a communication status signal which represents the acquired communication status as a response signal to the acquisition request signal.

In Step a9, the communication CH manager 21 performs communication status management processing for managing the communication status, which is represented by the communication status signal received from the wireless communication controller 22 in Step a8. In this embodiment, the communication CH manager 21 performs processing for storing the communication status, which is represented by the communication status signal received from the wireless communication controller 22, in the storage 11 through the integrated controller 20, the processing serving as communication status management processing.

In Step a10, the communication CH manager 21 notifies the communication status signal, which is received from the wireless communication controller 22 in Step a8, to the display output controller 24 through the integrated controller 20. In Step a11, the display output controller 24 transmits a display instruction signal, which represents an instruction to display the communication status based on the communication status signal notified from the communication CH manager 21 in Step a10, to the display output device 14. In Step a12, the display output device 14 displays the communication status based on the display instruction signal received from the display output controller 24.

Subsequently to the processing of Step a12 of FIG. 5, processing of Step a13 of FIG. 6 is performed. In Step a13, the N-th counterpart device AN transmits, to the wireless communication device 1, a connection request signal for requesting a connection between the wireless communication device 1 and the own device. The connection request signal transmitted to the wireless communication device 1 is received by the wireless communication controller 22 through the wireless communication unit 12 of the wireless communication device 1.

Upon receiving the connection request signal, the wireless communication controller 22 notifies a communication occurrence signal, which represents that the communication has occurred, to the communication CH manager 21 in Step a14. Moreover, in Step a15, the wireless communication controller 22 notifies the connection request signal to the display output controller 24 through the communication CH manager 21 and the integrated controller 20.

In Step a16, the display output controller 24 transmits a connection request display instruction signal, which represents an instruction to display that the connection request has been issued, to the display output device 14. Upon receiving the connection request display instruction signal, the display output device 14 displays that the connection request has been issued.

In Step a17, the communication CH manager 21 transmits, to the wireless communication controller 22, an acquisition request signal for requesting acquisition of the communication status at the present point of time. In Step a18, the wireless communication controller 22 acquires the communication status at the present point of time, and transmits, to the communication CH manager 21, a communication status signal which represents the acquired communication status as a response signal to the acquisition request signal.

In Step a19, the communication CH manager 21 performs communication status management processing for managing the communication status, which is represented by the communication status signal received from the wireless communication controller 22 in Step a18. Moreover, in Step a20, the communication CH manager 21 notifies the communication status signal, which is received from the wireless communication controller 22 in Step a18, to the display output controller 24 through the integrated controller 20.

In Step a21, the display output controller 24 transmits, to the display output device 14, a display instruction signal which represents an instruction to display the communication status based on the communication status signal notified from the communication CH manager 21 in Step a20. In Step a22, the display output device 14 displays the communication status based on the display instruction signal received from the display output controller 24.

Subsequently to the processing of Step a22 of FIG. 6, processing of Step a23 of FIG. 7 is performed. In Step a23, the information input device 13 is operated by the user, to input a connection response instruction, which represents an instruction to respond to the connection request issued from the N-th counterpart device AN, and the inputted connection response instruction is transmitted as a connection response instruction signal to the communication CH manager 21 through the information input controller 23 and the integrated controller 20.

Upon receiving the connection response instruction signal transmitted in Step a23, in Step a24, processing for establishing the communication with the N-th counterpart device AN is performed by the wireless communication device 1. In this way, the wireless communication device 1 and the N-th counterpart device AN turn to the communication state. Hence, at this point of time, the wireless communication device 1 is in the communication state with the first counterpart device A1 and the N-th counterpart device AN.

When the wireless communication device 1 and the N-th counterpart device AN turn to the communication state in this way, then in Step a25, the wireless communication controller 22 notifies a communication occurrence signal, which represents that the communication has occurred, to the communication CH manager 21.

In Step a26, the communication CH manager 21 transmits, to the wireless communication controller 22, an acquisition request signal for requesting the acquisition of the communication status at the present point of time. In Step a27, the wireless communication controller 22 acquires the communication status, and transmits, to the communication CH manager 21, a communication status signal which represents the acquired communication status as a response signal to the acquisition request signal.

In Step a28, the communication CH manager 21 performs communication status management processing for managing the communication status which is represented by the communication status signal received from the wireless communication controller 22 in Step a27. Specifically, the communication CH manager 21 performs processing for storing the communication status which is represented by the received communication status signal, in the storage 11 through the integrated controller 20.

In step a29, the communication CH manager 21 notifies the communication status signal, which is received from the wireless communication controller 22 in Step a27, to the display output controller 24 through the integrated controller 20. In Step a30, the display output controller 24 transmits a display instruction signal, which represents an instruction to display the communication status based on the communication status signal notified from the communication CH manager 21 in Step a29, to the display output device 14. In Step a31, the display output device 21 displays the communication status based on the display instruction signal received from the display output controller 24.

FIG. 8 is a perspective view showing an exterior appearance of the wireless communication device 1. The CPU 10, the storage 11, the wireless communication unit 12, the information input device 13 and the display output device 14, which are shown in FIG. 1, are provided in a wireless communication device main body (hereinafter, referred to as a “device main body”) 30. The voice output device 15, for example, a speaker is provided separately from the device main body 30, and is connected to the device main body 30.

The display output device 14 displays the communication status, for example, on a communication status display 32 provided on a part of a display screen 31. The voice output device 15 outputs the communication status as a voice. An operation unit 33 of the information input device 13 is provided, for example, below the display screen 31. The user inputs the connection request and the like by operating the operation unit 33.

FIG. 9 to FIG. 12 are views showing display examples of the communication status in the wireless communication device 1. FIG. 9 to FIG. 12 show cases of displaying the idle communication channels as the communication status on the communication status display 32 of the display output device 14 shown in FIG. 8. The display examples shown in FIG. 9 to FIG. 12 are display examples in the case of performing the communication by using the HV3 packet. In the communication using the HV3 packet, the communication is performed by three channels, and accordingly, the communication status display 32 is constituted by including three indicators 41 to 43 for example.

In the following description, indicators are referred to as a first indicator 41, a second indicator 42 and a third indicator 43 in order from a left side of each of FIG. 9 to FIG. 12. Each of the indicators 41 to 43 is configured so as to be switchable between a light-on state and a light-off state. At a stage where the power of the wireless communication device 1 is turned on, all of the indicators 41 to 43 are in the light-off state.

In response to the number of channels, which are being used, the three indicators 41 to 43 are lighted on in order of the first indicator 41, the second indicator 42 and the third indicator 43, and are switched from the light-off state to the light-on state. The number of indicators 41 to 43 in the light-off state corresponds to the number of idle communication channels.

For example, in a case where the wireless communication between the wireless communication device 1 and the counterpart device 2 is not performed, none of the three channels is used, and accordingly, the number of idle communication channels becomes three. In this case, as shown in FIG. 9, any of the indicators 41 to 43 is not lighted on, and all of the three indicators 41 to 43 turn to the light-off state. In this way, the fact that the number of idle communication channels is three is notified to the user.

In a case where the wireless communication device 1 performs the wireless communication with one of the counterpart devices 2, then one channel is being used, and accordingly, the number of idle communication channels becomes two. In this case, as shown in FIG. 10, the first indicator 41 among the three indicators 41 to 43 is lighted on, and turns to the light-on state. The rest of the second and third indicators 42 and 43 are not lighted, and turn to the light-off state. In this way, the fact that the number of idle communication channels is two is notified to the user.

In a case where the wireless communication device 1 performs the wireless communication with two of the counterpart devices 2, then two channels are being used, and accordingly, the number of idle communication channels becomes one. In this case, as shown in FIG. 11, the first and second indicators 41 and 42 among the three indicators 41 to 43 are lighted on, and turn to the light-on state. The rest of the third indicator 43 is not lighted, and turns to the light-off state. In this way, the fact that the number of idle communication channels is one is notified to the user.

In a case where the wireless communication device 1 performs the wireless communication with the three counterpart devices 2, then all of the three channels are being used, and accordingly, the number of idle communication channels becomes zero (0). In this case, as shown in FIG. 12, all of the three indicators 41 to 43 are lighted on, and turn to the light-on state, and the indicators 41 to 43 in the light-off state do not exist. In this way, the fact that the number of idle communication channels is zero (0), that is, the fact that there is no idle communication channel is notified to the user.

For example, the communication status of the wireless communication device 1 is sequentially changed to the states shown in FIG. 9 to FIG. 12. In a case where a connection to one of the counterpart devices 2 is disconnected from the state where there is no idle communication channel as shown in FIG. 12, and an idle communication channel becomes to exist as shown in FIG. 11, then the fact that the idle communication channel becomes to exist may be notified to the user also from the voice output device 15 shown in FIG. 8, for example, from the speakers. In this way, the user can instantaneously grasp that the idle communication channel becomes to exist, and accordingly, can quickly request the wireless communication device 1 to connect to a new counterpart device 2.

FIG. 13 and FIG. 14 are views showing a different display example of the communication status in the wireless communication device 1. In this display example, on the communication status display 32 of the display output device 14 shown in FIG. 8, a wireless communication channel, which is being used, a reception level of the wireless communication channel, and presence of an error are displayed as the communication status. The communication status display 32 is constituted by three indicators 51 to 53 shown in FIG. 13 and FIG. 14.

The indicators 51 to 53 shown in FIG. 13 and FIG. 14 are configured in a similar manner to the indicators 41 to 43 shown in FIG. 9 to FIG. 12. In the following description, indicators are referred to as a first indicator 51, a second indicator 52 and a third indicator 53 in order from a left side of each of FIG. 13 and FIG. 14. Each of the indicators 51 to 53 is configured so as to be switchable between the light-on state and a light-off state.

At a stage where the power of the wireless communication device 1 is turned on, all of the indicators 51 to 53 are in the light-off state. In response to the number of channels, which are being used, the three indicators 51 to 53 are lighted on in order of the first indicator 51, the second indicator 52 and the third indicator 53, and are switched from the light-off state to the light-on state. The number of indicators 51 to 53 in the light-on state represents the number of wireless communication channels (ch), which are being used. In other words, the number of indicators 51 to 53 in the light-off state represents the number of idle communication channels.

Moreover, in this display example, each of the indicators 51 to 53 is configured so as to be capable of changing an area of a region (hereinafter, referred to as “light-on region”), which is lighted, in response to the reception level of the wireless communication channel. The area of the light-on region of each of the indicators 51 to 53 represents the reception level of each of the wireless communication channels.

The area of the light-on region of each of the indicators 51 to 53 is changed, for example, by changing a length of the light-on region of the communication status display 32 in a lateral direction, that is, in a vertical direction of each of FIG. 13 and FIG. 14. As the reception level of the wireless communication channel is being higher, the length of the light-on region of the communication status manager 32 in the lateral direction becomes larger, and the area of the light-on region becomes larger.

FIG. 13 is a display example in a case where the wireless communication channel, which is being used, is one channel, and a reception level of the wireless communication channel is a half value of a maximum value. In this case, among the three indicators 51 to 53, only the first indicator 51 on a left end of FIG. 13 is lighted on and turns to the light-on state. The rest of the second and third indicators 52 and 53 are left in the light-off state. In this way, the fact that the number of idle communication channels is two is notified to the user.

Furthermore, the first indicator 51 is lighted on only in a lower half region of in FIG. 13 among the regions capable of being lighted on, and turns to the light-on state. In this way, the fact that the reception level of the wireless communication channel, which is being used, is a half of the maximum value is notified to the user.

Moreover, in this display example, a light-on region 50 of the first indicator 51 is displayed in different display colors in response to the reception level. For example, as shown in FIG. 13, in the case where the reception level is a half of the maximum value, the light-on region 50 of the first indicator 51 is displayed in yellowish green.

FIG. 14 is a display example in a case where the wireless communication channel, which is being used, is one channel, the reception level of the wireless communication channel is a half value of the maximum value, and an error occurs. As shown in FIG. 14, in the case where the error occurs, a light-on region 55 of the first indicator 51 is displayed in a display color different from the display color in the case shown in FIG. 13, where the error does not occur, for example, is displayed in yellow. The display color of the indicators 51 to 53 is changed depending on the presence of the error as described above, whereby the fact that the error occurs can be notified to the user.

As described above, according to the wireless communication device 1 of this embodiment, the idle communication channel is calculated by the communication CH manager 21 based on the communication status acquired by the wireless communication controller 22. The communication status includes the packet type of the communication packet that is being used. The idle communication channel is calculated based on this packet type. In this way, unlike the conventional technology, the idle communication channel can be obtained without providing means for obtaining the communication status, such as means for measuring the radio wave intensity. Hence, the idle communication channel can be obtained with a simple configuration.

Moreover, in this embodiment, notification information including the idle communication channel information related to the obtained idle communication channel is outputted to either one or both of the display output device 14 and the voice output device 15. In this way, the notification information including the idle communication channel information can be notified to the user, and accordingly, the user can accurately determine the current communication status, and can avoid an unnecessary connection.

In this embodiment, the notification information including the idle communication channel information is outputted as a video by the display output device 14, and accordingly, the notification information including the idle communication channel information can be visually notified to the user. Hence, the user can easily grasp the current communication status including the idle communication channel.

Moreover, in this embodiment, it is also possible to output the notification information including the idle communication channel information, as a voice by the voice output device 15. In this way, even in a case where the user cannot look at the display output device 14, the notification information including the idle communication channel information can be notified to the user. For example, even when the user is driving an automobile in a case where the wireless communication device 1 is a navigation device and is mounted on the automobile, the notification information including the idle communication channel information can be notified to the user. Hence, the user can quickly grasp the current communication status including the idle communication channel.

Moreover, in this embodiment, the communication status acquired by the communication CH manager 21 includes the reception level and the presence of an error, and the notification information outputted by the display output device 14 and the voice output device 15 includes reception level information and error information. For example as shown in FIG. 13 and FIG. 14, the reception level information is displayed as the area of the lighted region 50 of the indicator 51 on the communication status display 32 of the display screen 14 of the display output device 14. For example, as shown in FIG. 14, the error information is displayed as the display color of the lighted region 55 of the indicator 51.

As described above, at least either one of the reception level information and the error information is outputted by the display output device 14, the voice output device 15 and the like, whereby a more detailed communication status can be notified to the user. In this way, the user can determine the current communication status more accurately, and accordingly, the unnecessary connection can be avoided more surely.

In the embodiment mentioned above, the communication status is displayed on the display output device 14 of the wireless communication device 1; however, the communication status may be displayed also on display output devices of the counterpart devices 2. FIG. 15 to FIG. 17 are views showing an example of a sequence in a case of displaying the communication status on the display output devices of the counterpart devices 2. FIG. 15 to FIG. 17 show a case where the wireless communication device 1 is in an operation state in Step b1, the first counterpart device A1 is in an operation state in Step b2, and the N-th counterpart device AN is in an operation state in Step b3.

In Step b4, the information input device 13 is operated by the user, to input a connection request for requesting a connection to the first counterpart device A1, and the inputted connection request is transmitted as a connection request signal to the communication CH manager 12 through the information input controller 23 and the integrated controller 20.

Upon receiving the connection request signal in Step b4, in Step b5, processing for establishing the communication with the first counterpart device N1 is performed by the wireless communication device 1. In this way, the wireless communication device 1 and the first counterpart device A1 turn to a communication state.

When the wireless communication device 1 and the first counterpart device N1 turn to the communication state in such a manner, then in Step b6, the wireless communication controller 22 notifies a communication occurrence signal, which represents that the communication has occurred, to the communication CH manager 21.

In Step b7, the communication CH manager 21 transmits, to the wireless communication controller 22, an acquisition request signal for requesting acquisition of the communication status at the present point of time. In Step b8, the wireless communication controller 22 acquires the communication status, and transmits, to the communication CH manager 21, a communication status signal which represents the acquired communication status as a response signal to the acquisition request signal.

In Step b9, the communication CH manager 21 performs communication status management processing for managing the communication status, which is represented by the communication status signal received from the wireless communication controller 22 in Step b8. In this example, the communication CH manager 21 performs processing for storing the communication status, which is represented by the communication status signal received from the wireless communication controller 22, in the storage 11 through the integrated controller 20, the processing serving as communication status management processing.

In Step b10, the communication CH manager 21 notifies the communication status signal, which is received from the wireless communication controller 22 in Step b8, to the display output controller 24 through the integrated controller 20. In Step b11, the display output controller 24 transmits, to the display output device 14, a display instruction signal, which represents an instruction to display the communication status based on the communication status signal notified from the communication CH manager 21 in Step b10. In Step b12, the display output device 14 displays the communication status based on the display instruction signal received from the display output controller 24.

Subsequently to the processing of Step b12 of FIG. 15, processing of Step b13 of FIG. 16 is performed. In Step b13, the N-th counterpart device AN transmits, to the wireless communication device 1, a communication status request signal for requesting the notification of the communication status. The communication status request signal transmitted to the wireless communication device 1 is received by the wireless communication controller 22 through the wireless communication unit 12 of the wireless communication device 1.

Upon receiving the communication status request signal, the wireless communication controller 22 transmits the communication status request signal to the communication CH manager 21 in Step b14. Upon receiving the communication status request signal transmitted in Step b14, processing for establishing the communication with the N-th counterpart device AN is performed by the wireless communication device 1 in Step b15. In this way, the wireless communication device 1 and the N-th counterpart device AN turn to the communication state. Hence, at this point of time, the wireless communication device 1 is in the communication state with the first counterpart device A1 and the N-th counterpart device AN.

When the wireless communication device 1 and the N-th counterpart device AN turn to the communication state in such a way, then in Step b16, the wireless communication controller 22 notifies, to the communication CH manager 21, a communication occurrence signal which represents that the communication has occurred.

In Step b17, the communication CH manager 21 transmits, to the wireless communication controller 22, an acquisition request signal for requesting the acquisition of the communication status at the present point of time. In Step b18, the wireless communication controller 22 acquires the communication status, and transmits, to the communication CH manager 21, a communication status signal which represents the acquired communication status as a response signal to the acquisition request signal.

In Step b19, the communication CH manager 21 performs communication status update processing for updating the communication status, which is represented by the communication status signal received from the wireless communication controller 22 in Step b18. Specifically, the communication CH manager 21 performs, through the integrated controller 20, processing for updating the communication status which is stored in the storage 11 by rewriting the communication status represented by the communication status signal received in Step b18.

In Step b20, the communication CH manager 21 notifies the communication status signal, which is received from the wireless communication controller 22 in Step b18, to the display output controller 24 through the integrated controller 20. Moreover, in Step b21, the communication CH manager 21 transmits, to the wireless communication controller 22, the communication status signal which is received from the wireless communication controller 22 in Step b18 as a response signal to the communication status request signal.

In Step b22, the display output controller 24 transmits, to the display output device 14, a display instruction signal which represents an instruction to display the communication status based on the communication status signal notified from the communication CH manager 21 in Step b20. In Step b23, the display output device 14 displays the communication status based on the display instruction signal received from the display output controller 24.

In Step b24, the wireless communication controller 22 transmits, to the N-th counterpart device AN, the communication status signal which is received from the communication CH manager 21 in Step b21, as a response signal to the communication status request signal. In Step b25, the N-th counterpart device AN displays the communication status, which is represented by the communication status signal received in Step b24, on a display output device thereof.

Subsequently to the processing of Step b25 of FIG. 16, processing of Step b26 of FIG. 17 is performed. In Step b26, the N-th counterpart device AN transmits, to the wireless communication device 1, a disconnection request signal which represents a communication disconnection request for requesting disconnection of the communication between the wireless communication device 1 and the own device. The disconnection request signal transmitted to the wireless communication device 1 is received by the wireless communication controller 22 through the wireless communication unit 12 of the wireless communication device 1. When the wireless communication controller 22 receives the disconnection request signal, communication disconnection processing for disconnecting the communication with the N-th counterpart device AN is performed by the wireless communication device 1, and the processing proceeds to Step b27.

In Step b27, the wireless communication controller 22 notifies, to the communication CH manager 21, a disconnection signal which represents that the communication with the N-th counterpart device AN is disconnected. Moreover, in Step b28, the wireless communication controller 22 transmits, to the N-th counterpart device AN through the wireless communication unit 12, a disconnection completion signal, which represents that the communication disconnection processing is completed.

In Step b29, the communication CH manager 21 transmits, to the wireless communication controller 12, an acquisition request signal for requesting acquisition of the communication status at the present point of time. In Step b30, the wireless communication controller 22 acquires the communication status, and transmits, to the communication CH manager 21, a communication status signal which represents the acquired communication status as a response signal to the acquisition request signal.

In Step b31, the communication CH manager 21 performs communication status update processing for updating the communication status, which is represented by the communication status signal received from the wireless communication controller 22 in Step b30. Specifically, the communication CH manager 21 performs, through the integrated controller 20, processing for updating the communication status which is stored in the storage 11 by rewriting the communication status represented by the communication status signal received in Step b30.

In Step b32, the communication CH manager 21 notifies the communication status signal, which is received from the wireless communication controller 22 in Step b30, to the display output controller 24 through the integrated controller 20. In Step b33, the display output controller 24 transmits, to the display output device 14, a display instruction signal, which represents an instruction to display the communication status based on the communication status signal notified from the communication CH manager 21 in Step b32. In Step b34, the display output device 14 displays the communication status based on the display instruction signal received from the display output controller 24.

As described above, the notification information including the idle communication channel information can be outputted by the display output device, voice output device and the like of the counterpart device 2 by the transmission from the wireless communication unit 12 to the counterpart device 2. For example, the notification information including the idle communication channel information can be displayed on the display output device of the counterpart device 2. The notification information including the idle communication channel information is outputted by the display output device, voice output device and the like of the counterpart device 2 in such a manner, whereby the user can grasp the current communication status including the idle communication channel more easily.

Although the present invention has been described in detail, the above description is illustrated in all aspects, and the present invention is not limited to this. It is understood that numerous modification examples which are not illustrated can be thought of without departing from the scope of the present invention.

### EXPLANATION OF REFERENCE NUMERALS

1 WIRELESS COMMUNICATION DEVICE, 2 COUNTERPART DEVICE, 10 CPU, 11 STORAGE, 12 WIRELESS COMMUNICATION UNIT, 13 INFORMATION INPUT DEVICE, 14 DISPLAY OUTPUT DEVICE, 15 VOICE OUTPUT DEVICE, 20 INTEGRATED CONTROLLER, 21 COMMUNICATION CH MANAGER, 22 WIRELESS COMMUNICATION CONTROLLER, 23 INFORMATION INPUT CONTROLLER, 24, DISPLAY OUTPUT CONTROLLER, 25 VOICE OUTPUT CONTROLLER

1. A wireless communication device comprising:
wireless communication unit that performs wireless communication with a counterpart device by using Bluetooth;
status acquisition unit that acquires a communication status of said wireless communication performed by said wireless communication unit; and
channel calculation unit that calculates an idle communication channel based on said communication status acquired by said status acquisition unit, the idle communication channel being usable by said wireless communication unit in said wireless communication, wherein
said communication status includes a packet type of a communication packet being used, and
said channel calculation unit calculates said idle communication channel based on said packet type.

2. The wireless communication device according to claim 1, further comprising:
display output unit that outputs, as a video, notification information including idle communication channel information related to said idle communication channel calculated by said channel calculation unit.

3. The wireless communication device according to claim 1, further comprising:
voice output unit that outputs, as a voice, notification information including idle communication channel information related to said idle communication channel calculated by said channel calculation unit.

4. The wireless communication device according to claim 1,
wherein said wireless communication unit transmits, to said counterpart device, notification information including idle communication channel information related to said idle communication channel calculated by said channel calculation unit.

5. The wireless communication device according to claim 2, wherein
said communication status includes at least either one of a reception level and presence of an error, and
said notification information includes at least either one of reception level information related to said reception level and error information related to said presence of an error.

6. A wireless communication method of performing wireless communication with a counterpart device by using Bluetooth, the wireless communication method comprising:
a status acquisition step of acquiring a communication status of said wireless communication; and
a channel calculation step of calculating an idle communication channel based on said communication status acquired by said status acquisition step, the idle communication channel being usable in said wireless communication, wherein
said communication status includes a packet type of a communication packet being used, and
said idle communication channel is calculated based on said packet type in said channel calculation step.

7. The wireless communication method according to claim 6, further comprising:
a step of outputting notification information as a video by display output unit, the notification information including idle communication channel information related to said idle communication channel calculated by said channel calculation step.

8. The wireless communication method according to claim 6, further comprising:
a step of outputting notification information as a voice by voice output unit, the notification information including idle communication channel information related to said idle communication channel calculated by said channel calculation step.

9. The wireless communication method according to claim 6, further comprising:
a step of transmitting notification information to said counterpart device, the notification information including idle communication channel information related to said idle communication channel calculated by said channel calculation step.

10. The wireless communication method according to claim 7, wherein
said communication status includes at least either one of a reception level and presence of an error, and
said notification information includes at least either one of reception level information related to said reception level and error information related to said presence of an error.
